(19) United States
(12) Patent Application Publication
(10) Pub. No.: US 2009/0258773 A1
(43) Pub. Date: Oct. 15, 2009

(54) CRAFT KITS

(76) Inventor: Benjamin Holmes Peter Shine, Canberra (AU)

Correspondence Address: Fay Sharpe LLP, 1228 Euclid Avenue, 5th Floor, The Halle Building, Cleveland, OH, 44115, US

(21) Appl. No.: 12/375,323

(22) PCT Filed: Jun. 26, 2007
(86) PCT No.: PCT/GB2007/002372

§ 371 Date: May 13, 2009

(30) Foreign Application Priority Data
Jul. 27, 2006 (GB) 0614982.7

(51) Int. Cl. B31D 99/00

(52) U.S. Cl. 493/393

(57) ABSTRACT

A craft kit for producing artwork using one or more lengths of flexible material includes a substrate. The lengths of flexible material can be lengths of cord which are attachable to the substrate by, for example, retaining elements, a hook and loop fastener or magnetic attraction to form representations in which the strips appear imitative of pen or brush strokes. A stylus can be used to apply the fabric to the substrate. The substrate may be made of wood, metal or fabric, such as an item of clothing or a piece of folded cardboard.

This invention relates to craft kits.

According to a first aspect of the invention there is provided a craft kit for producing artwork using one or more lengths of flexible material such as strips of fabric, comprising a plurality of retaining elements each of which is attachable at a point on a substrate and each of which is capable of holding said material length at that point, the material lengths being threadable between selected ones of said retaining elements whereby to form a representation in which the material lengths appear imitative of pen or brush strokes.

According to a second aspect of the invention there is provided a craft kit for producing artwork, comprising one or more elongate flexible strips, e.g. lengths of cord, a substrate, and means enabling the or each strip to be releasably held in position on said substrate when applied thereto whereby to form a representation in which the strip or strips appear imitative of pen or brush strokes.

By way of example, various embodiments of the invention will now be described with reference to the accompanying drawings, in which:

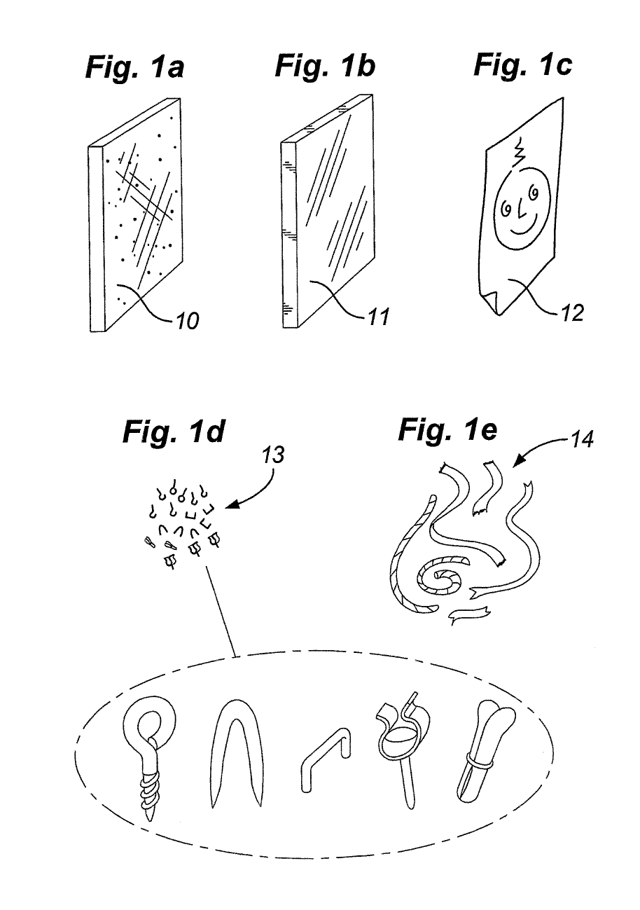

FIGS. 1a to 1e illustrate the basic elements that make up a form of craft kit according to the invention,

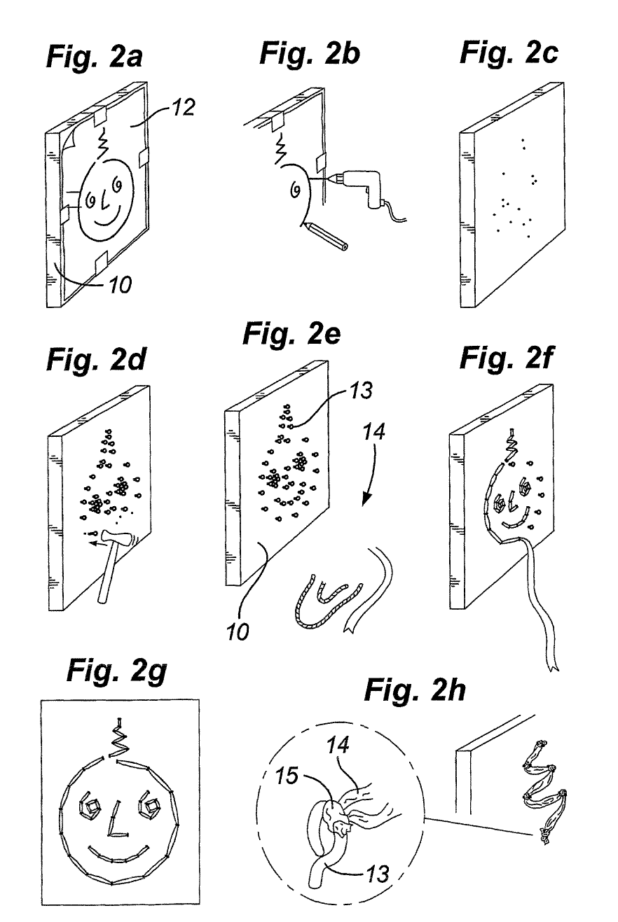

FIGS. 2a to 2h illustrate the various steps involved in producing a piece of artwork from the craft kit of FIG. 1,

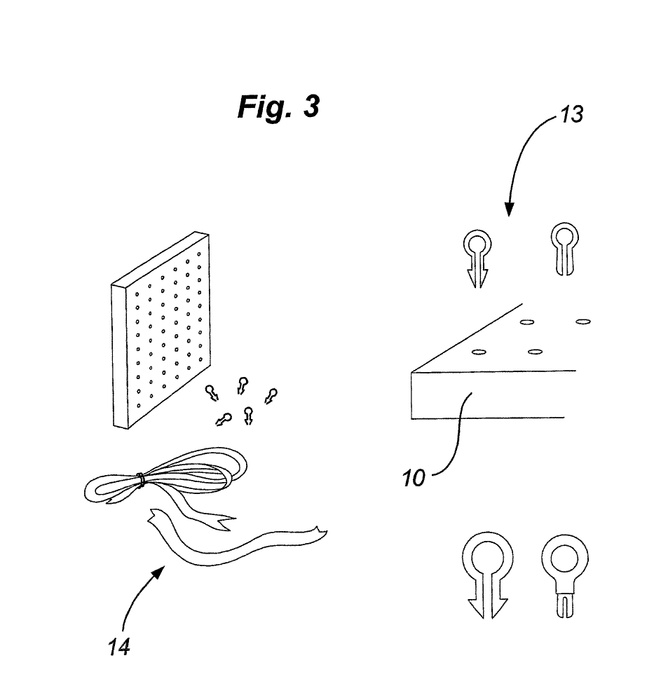

FIG. 3 illustrates a modified form of the craft kit illustrated in FIG. 1,

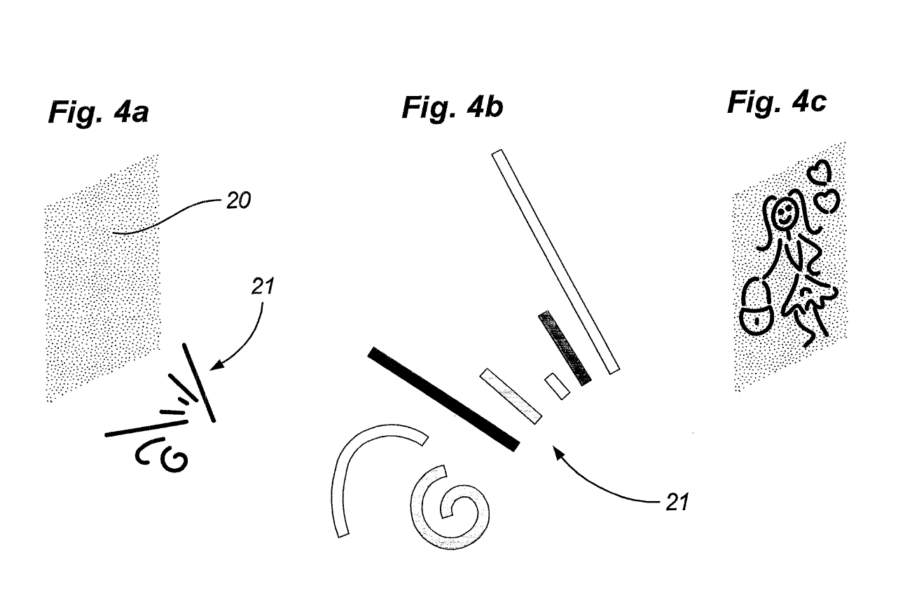

FIGS. 4a to 4c illustrate an alternative form of craft kit according to the invention, and

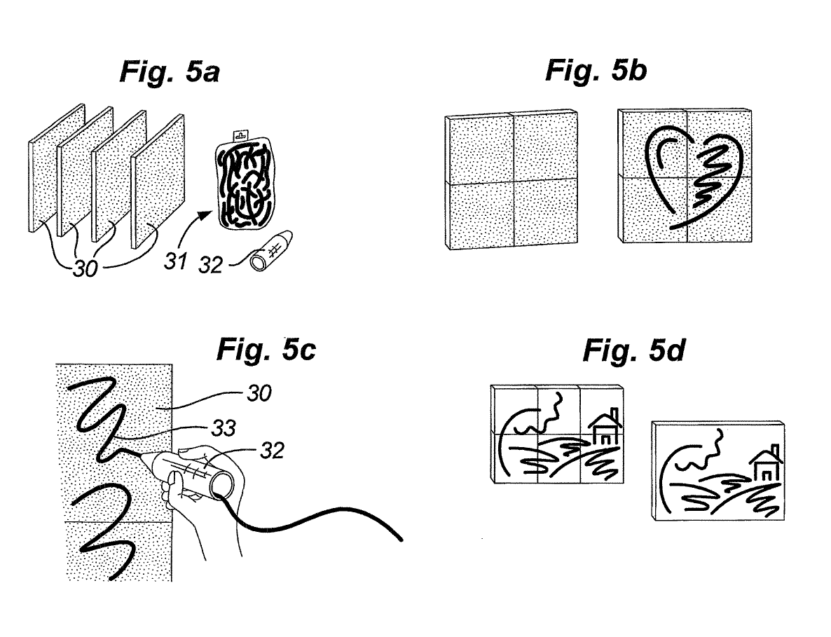

FIGS. 5 to 12 illustrate various adaptations to the form of craft kit of FIGS. 4a to 4c and various additional elements for use therewith.

A craft kit according to the invention comprises a number of elements, which are seen in FIGS. 1a to 1e. These elements include a substrate 10 made of wood, metal or other suitable material (FIG. 1a), onto which a fabric or other surface material 11 may be applied (FIG. 1b). This front surface may be made of solid material, such as plastic, wood, metal, marble, glass or resin. The substrate 10 may be fixed to a frame to form the base of a tray. A template 12 carries a representation of the picture to be produced (FIG. 1c). This may be a physical template or a CAD file which clearly describes the image to be created. The template may include colours and show the position where a number of retaining elements 13 (FIG. 1d) are to be mounted on the substrate 10 within the composition of the image. These retaining elements 12 may take a number of different forms, some of which are illustrated in the enlarged detail of FIG. 1d. Finally, there are a number of strips of material 14 such as fabric, ribbon, cord and the like (FIG. 1e).

The purpose of the retaining elements 13 is to hold the material strips 14 in position on, against or adjacent to the substrate 10. They are also designed to enable the material strips 14 to be threaded between the various retaining elements 13 during the making of a piece of artwork, as will be described in more detail below. In their simplest form, the retaining elements 13 may be screw eyes, which are screwed into holes in the substrate 10.

FIGS. 2a to 2h shows the steps in the production of a piece of artwork using the craft kit of FIG. 1. First, the image 12 to be created is superimposed (manually by a physical template or by Computer-Aided-Design) onto the surface material on the substrate 10 (FIG. 2a). Then, holes are drilled into the substrate at positions marked off the template (manually or by machine), as seen in FIG. 2b.

Once the holes have been drilled or marked, the template is removed from the surface to reveal a mass of drilled holes or marks in the pattern of the template image (FIG. 1c). The relevant number of retaining elements are then mounted on the substrate in these holes (FIG. 2d).

The material strips 14 of fabric, ribbon, cord or the like are then threaded through the retaining elements 13 to create individual linear shapes (FIGS. 2e and 2f). The positioning, colour and correct weaving of the material strips 14 through the retaining elements 13 is continually checked by referring to the original template design (FIG. 1c) which clearly shows the pre-designed layout of the linear shapes and their individual colours within the composition of the image. It may be preferred that the template design (FIG. 1c) offers a basic guide from which the user may be able to deviate and interpret his or her own variations in the weaving and formations of the material strips around the retaining elements.

It will be noted that the retaining elements 13 allow the material strips 14 to be applied to the substrate 10 in a variety of different ways. For example, the strip 14 can be loosely draped between the retaining elements 13 or strung tightly between them, depending on what is required for that part of the image or how the user wishes to create the look. Also, the strips 14 may be passed through the retaining elements 13 a number of times or wrapped around them or knotted. The overall impression created by the strips of material 14 extending between the various retaining elements 13 is of an artist's pen or brush strokes.

A further feature of the retaining elements 13 in this embodiment is their ability to be rotated in their holes in the substrate 10. This has the benefit of enabling subtle alterations or tweaks to be made to the image being created. In a portrait picture, for example, a retaining element 13 at the corner of a mouth could be oriented upwardly to give the face a smiling appearance or downwardly to create a more sombre countenance. This ability to subtly alter the shapes within the composition gives the craft kit great flexibility and aids the potential for accuracy in creating the desired image.

Knots 15 which are tied to secure a material strip 14 to a retaining element 13 at the end of a linear shape can be placed at a preferred position on the retaining element. For example, the knot 15 may be pushed to sit somewhat under the retaining element 13 or it may be positioned at its mid-point (FIG. 2h), allowing the material strip 14 to remain visible at this point, whilst substantially concealing the retaining element.

It will be noted that the retaining elements 13 allow relatively wide material strips 14 to be used, which can then be contorted. Irregular forms can be formed into different configurations, such as by folding, twisting, bunching and so on. The material strips 14 are constricted by the retaining elements 13 as they pass through them. This has the benefit of adding physical texture and three dimensional form to the image and a deeper, concentrated colour of line, as well as enhancing the character and style of the image.

The retaining elements 13 may be designed to hold the material strips generally on or against the surface of the substrate 10 or spaced therefrom, not necessarily all by the same distance. It will be understood that the retaining elements 13 may take many different forms. They can comprise a closed loop, such as a screw eye, or have a more open configuration, in the manner of a forked or sprung clip. Also, as seen in FIG. 3, the retaining elements 13 could be in the form of an eyelet mounted on a stem which simply push-fits into holes in the substrate.

An alternative form of craft kit is seen in FIGS. 4a to 4c. This essentially comprises a substrate 20 on which a variety of coloured and individually sized elongate flexible strips 21 are mounted. The strips 21 are designed to be releasably held in position on the substrate 20 when applied thereto. The preferred mechanism to achieve this releasable attachment is in the nature of a hook and loop fastener (Velcro). For this purpose the substrate 20 is provided with hook fasteners on its surface. The strips 21 are of a fibrous material, for example lengths of cord, so that when applied to the substrate 20, they will be retained by action of the hook fasteners on the fibres. This allows individual strips 21 to be shaped and placed on the substrate 20 to create an overall image or pattern. Each strip 21 may be easily detached from the substrate 20 using this attachment mechanism so that it may be readily rearranged to allow new and unlimited flexibility in creating further patterns, images or designs. This avoids the problems of existing craft kits, which are often messy as they involve inks/paint/crayons or the like which can cause unwanted dirt and stains to occur and they do not provide a clean stain free alternative. Also, whilst existing craft kits typically relate to puzzles and 3D forming objects which require a degree of ‘problem solving’ by the user, they offer no ability for the user to create his own unique image.

The user applies the various strips 21 (FIG. 4b) to the substrate 20 (FIG. 4a) to form an image (FIG. 4c) in which the strips are akin to pen or brush strokes made by an artist. The process of applying the strips 21 to the substrate 20 may be worked by hand, flat on a table top, on the floor, on a designed plinth or, on an easel. Alternatively, the substrate 20 may be fixed to a wall or it may be free standing with its own back-stand for support.

An alternative form of mechanism to allow the releasable attachment of the strips to the substrate is one that uses magnetic force. For this, magnetically attractive particles could be contained within the core of the strips, making the strips attractive to the substrate, which is also of a magnetically attractive material.

The strips 21 may be produced as flexible sticks or cords and may be made from woven, knitted, sewn or heat-sealed material. They may be made from nylon, plastic, fabric, rubber, foam, wire wool or metal, and may include magnetic material or hook and loop material or be produced in any combination of such materials together in order that they may fix to, and be easily unstuck from the substrate 20. The fixing cords may take the form of varying lengths, diameters, colours, and textures. They may be patterned or plain and may be luminous and may glow in the dark.

The strips 21 may also be numbered or coded for purposes of identification in order to aid the construction process and to help the user when working from a template design. The strips 21 may be sealed at each end to prevent fraying and additional linking devices may be provided so that two or more strips may be linked together from end to end to create long lengths.

The form of craft kit seen in FIGS. 5a to 5d comprises a number of substrates 30, a pack of elongate flexible strips 31 and a stylus 32 (FIG. 5a). The substrates 30 are in the nature of tiles which can be placed side by side to make a bigger picture (FIG. 5d). The substrates 30 have hook fasteners (or magnetically attractive material) over substantially their whole surface.

The stylus 32 is a pen-like object, comprising a hollow container that is capable of holding one or more lengths of strip material 33. The user places the stylus 32 against the substrate 30 (FIG. 5c). When the tip of the strip 33 protruding from the nib end of the stylus 32 makes contact with the substrate 30, it will stick to it. When the stylus 32 is then moved across the substrate 30, the strip of material 33 will stick to the substrate as it gets drawn out of the stylus, in the direction that the stylus is moved. Thus, the strip 33 can be positioned on the substrate 30 in a manner akin to the drawing of a line. The stylus 32 aids in the accuracy of placing the strips 33 where the user wishes and offers a fast and effective manner with which to draw, especially when using very long strips. The stylus 32 is of such a design that it can be held in one hand and used like a pen. It may be made of several materials including, plastics, foam, wood or metal and may be, though not exclusively, tubular in design with a funnel at one end to act as the nib outlet for the strips. The stylus 32 may be pre-loaded with a long length of strip material and a kit may be supplied with a number of styli, each containing a strip 33 of a different colour. It will be noted that the strip 33 can quite easily be reloaded into the stylus 32 for re-use. The stylus 32 may incorporate a cutting device at its nib end to enable the user to cut the strips 33 into individual sections when applying them to the substrate.

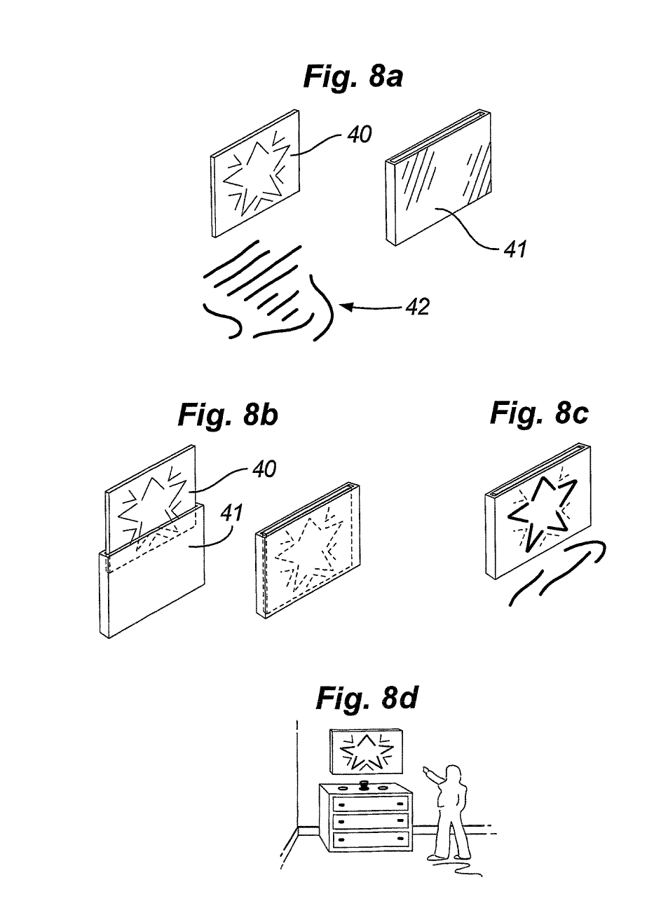

The craft kit may be supplied with one or more kinds of template to assist the user in creating images. In one form, the template is in the nature of a stencil 40 (FIGS. 8a and 8d). Here, the stencil 40 containing a representation of an image fits behind the substrate 41, which for the purpose is transparent or at least partly so (FIG. 8b), and in the form of a shallow box. A backlight may be used to enhance the stencil image on the substrate. The user chooses the appropriate strips 42 and places them on the substrate 41 to re-create the stencil image (FIG. 8c). The finished article may be hung on a wall (FIG. 8d) or be free standing, with or without the stencil 40 still present.

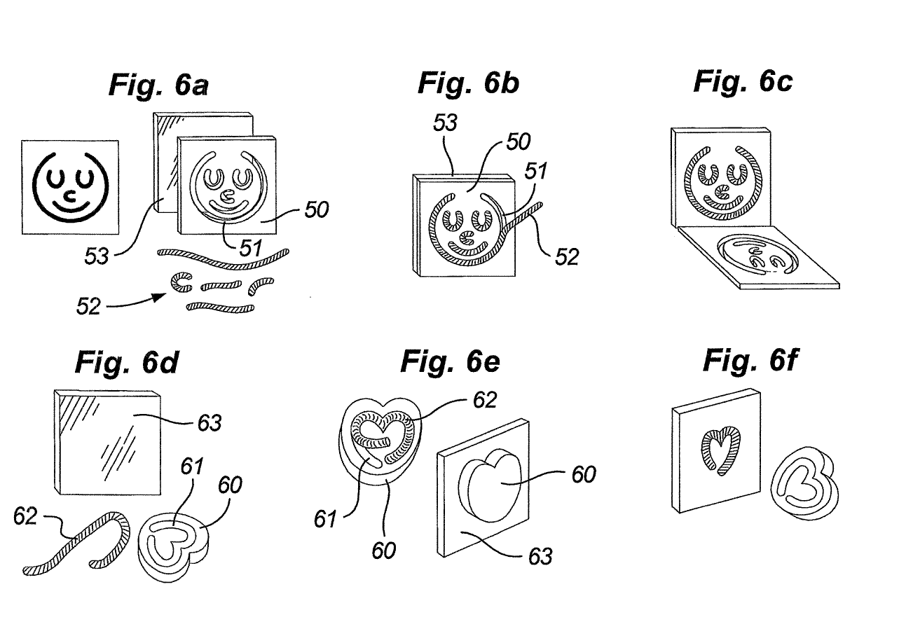

In another form (FIGS. 6a to 6c), the template is in the nature of a mask 50 with a pattern of cutouts 51 to receive strips 52. If the mask 50 is placed over the substrate 53, appropriate strips 52 can be chosen and attached to the substrate through the cutouts 51, as seen in FIG. 6b. The mask 50 can then be removed to reveal the desired image on the substrate (FIG. 6c). The mask 50 may include markings, for example natural numbers, indicative of a length of strip 52 that corresponds to the length of an associated cutout 51. A strip 52 can be measured and matched or paired with one or more cutouts 51 on the basis of its length.

In another form (FIGS. 6d to 6f), the template is in the nature of a mould 60, with a pattern of cavities 61 in its surface to receive strips 62. The strips 62 are chosen and placed in the cavities 61 as appropriate and the mould 60 is then applied to the substrate 63 (FIG. 6e). When the mould is removed, the strips 62 remain attached to the substrate 53 forming the desired image.

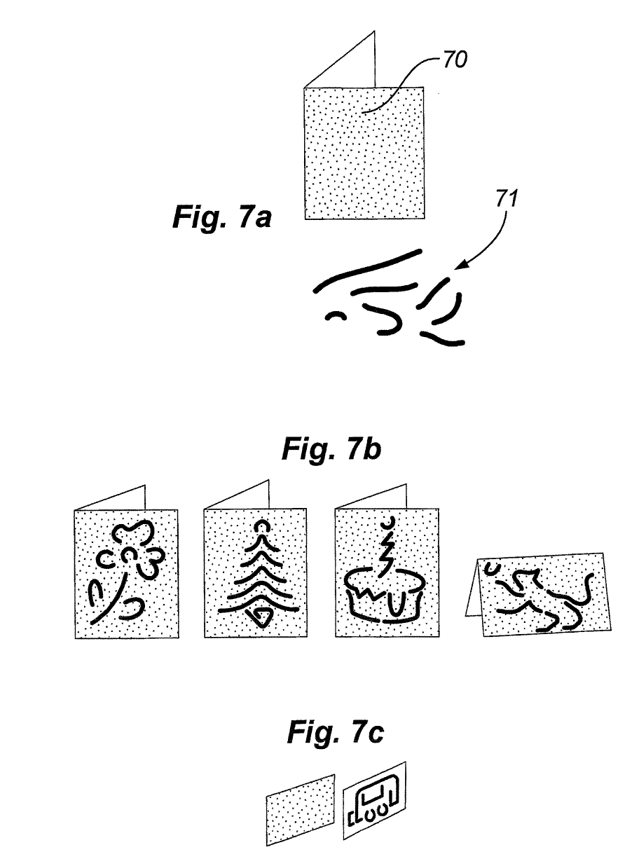

An alternative form of craft kit is seen in FIGS. 7a to 7c. Here, the substrate is in the form of a greetings card 70, with the substrate forming the front surface. The substrate 70 incorporates hook fasteners (or magnetically attractive material) over substantially its whole surface. Provided with this kit are a specific number of strips 71 of specific length and colour. Also included are a number of suggested images that can all be formed using the same strips. The user can choose which of the images he wishes to create, depending on the intended recipient of the card.

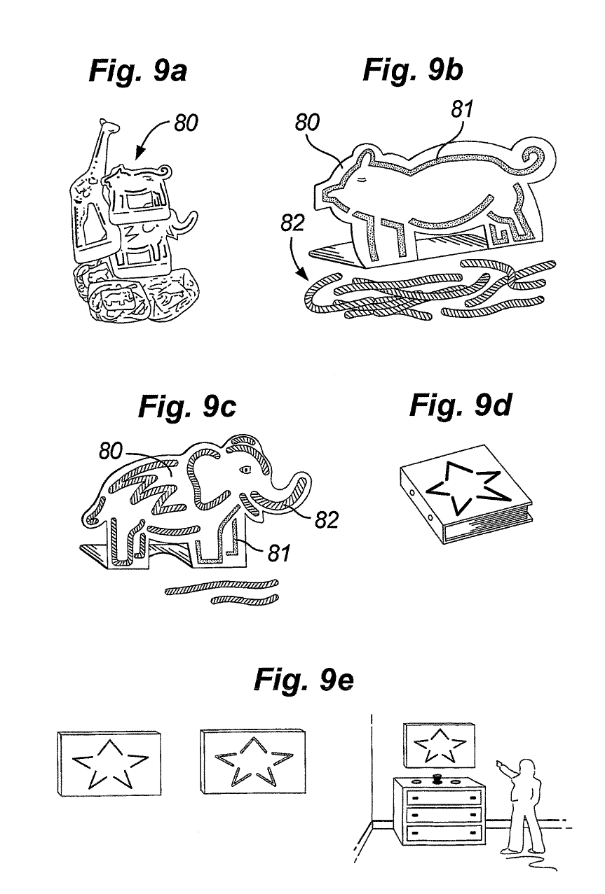

Further variations are illustrated in FIGS. 9a to 9e. Here, the substrate 80 is formed into the outline of a recognisable object, for example an animal. The substrate 80 incorporates hook fasteners (or magnetically attractive material), as in previous embodiments, but here, these are provided only in discrete areas 81 of the substrate. The idea is for the user to choose appropriate strips 82 and apply them to the discrete areas 81 on the substrate 80 (FIGS. 9b and 9c). These kits could be used to form a variety of products, such as greetings cards, free-standing ornaments, book jackets (FIG. 9d) or pictures for mounting on a wall (FIG. 9e).

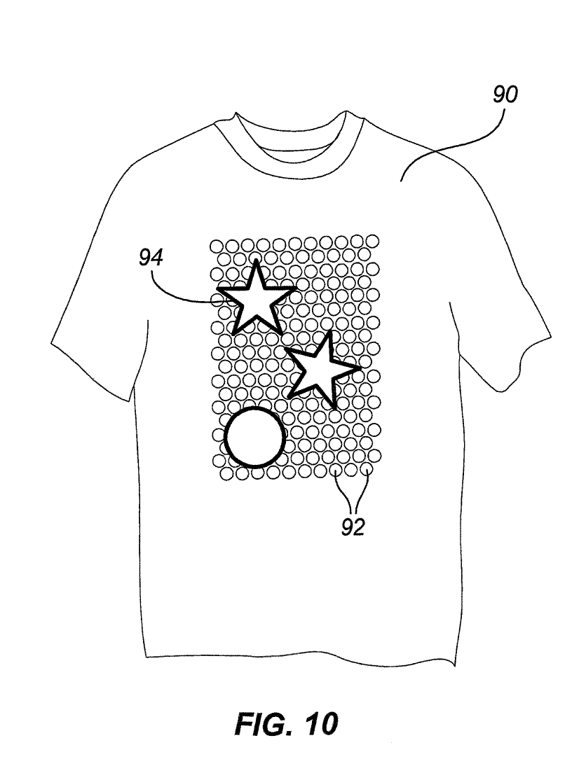

FIG. 10 shows an alternative form of craft kit, wherein the substrate is in the form of a t-shirt, jumper, or other item of clothing 90. The front surface of the t-shirt 90 incorporates many small circular regions of hook fasteners (or magnetically attractive material) 92. Strips 94 can be applied to the regions 92 as explained above. Instead of providing a single, large region of hook fasteners which may make the t-shirt 90 stiff and uncomfortable to wear, providing smaller regions can reduce this. Alternatively or additionally, the rear surface of the t-shirt (not shown) may include attachment regions (not shown).

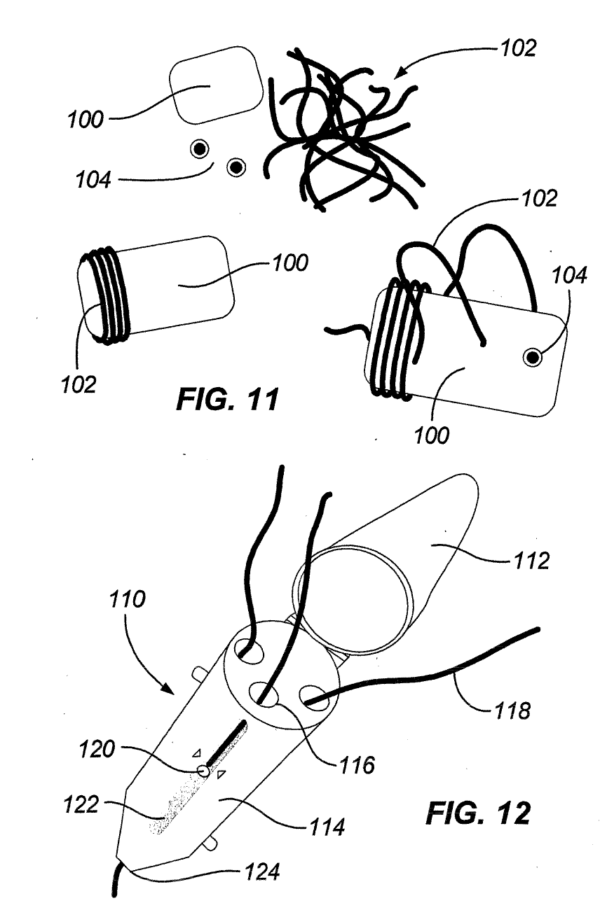

FIG. 11 shows another alternative form of craft kit in which the substrate is in the form of a solid shape 100 providing a generally closed surface. The closed surface is covered with hook fasteners (or is covered with, or has inside, magnetically attractive material) over substantially its whole surface. The craft kit also includes strips of material generally indicated at 102 and, optionally, further accessories 104 such as so-called “boggley eyes”. The material 102 may be in the form of a cord having a flexible, semi-rigid wire core. In the same way as that described above, the material 102 and accessories 104 are applied to the substrate 100, to form the desired design.

FIG. 12 shows a tri-stylus 110 having a hinged lid 112 connected to a gripping body 114 having three cylindrical passages 116 for receiving a respective piece of material 118 therein. A peg 120 projects through a respective window 122 formed in an outer face of the gripping body 114. The peg 120 is connected near an open tip or nib 124 of the stylus 110 by means of a resilient member (not shown), which in this example is a helical spring. The resilient member biases the peg 120 towards the lid-end of the window 122. In use, the lid 112 is opened and each piece of material 118 is fed into a respective passage 116 until a tip of the material is aligned with indica 126, for example a pair of triangles pointing towards the window 122, on the outer surface of the gripping body 114. Then, the peg 120 is depressed radially inwardly so as to trap the material. The peg and trapped material are slid towards the nib 124. The peg 120 is then released so as to return to its lid-end position and the material 118 is free to flow out of the stylus 110 as desired.

1. A craft kit for producing artwork using one or more lengths of flexible material such as strips of fabric, comprising a plurality of retaining elements each of which is attachable at a point on a substrate and each of which is capable of holding said material length at that point, the material lengths being threadable between selected ones of said retaining elements whereby to form a representation in which the material lengths appear imitative of pen or brush strokes.

2. A craft kit as claimed in claim 1 wherein the retaining elements are attachable to said substrate such that their orientation is adjustable.

3. A craft kit as claimed in claim 1 wherein the retaining elements hold said material lengths at points spaced from the surface of said substrate.

4. A craft kit as claimed in claim 1 wherein each retaining element is capable of holding a plurality of material lengths or a plurality of portions of a single material length.

5. A craft kit as claimed in claim 1 wherein the retaining elements are attachable to the substrate at selected points corresponding to the intended representation.

6. A craft kit for producing artwork, comprising one or more elongate flexible strips, e.g. lengths of cord, a substrate, and means enabling the or each strip to be releasably held in position on said substrate when applied thereto whereby to form a representation in which the strip or strips appear imitative of pen or brush strokes.

7. A craft kit as claimed in claim 6 wherein the releasable holding means is provided only at certain selected locations on the substrate.

8. A craft kit as claimed in claim 6 wherein the releasable holding means extends substantially across the entire substrate.

9. A craft kit as claimed in claim 6 and further comprising a masking template to fit over the substrate, the masking template having cut outs therein to act as guides for the application of a strip or strips to the substrate.

10. A craft kit as claimed in claim 6 and further comprising a stencil template to fit behind said substrate, said stencil template bearing indications to act as a guide for the application of a strip or strips to the substrate, said indications being visible through the substrate.

11. A craft kit as claimed in claim 10 and further comprising a light source for enhancing the visibility of the stencil template through the substrate.

12. A craft kit as claimed in claim 6 and further comprising a mould template, the mould template having shaped recesses to receive a strip or strips and allow said strip or strips to be transferred onto the substrate in said shape by application of the mould template to the substrate.

13. A craft kit as claimed in claim 6 and further comprising a stylus for containing a strip, the stylus having an orifice through which the strip may be dispensed, allowing the stylus to be used to apply the strip to the substrate.

14. A craft kit as claimed in claim 13 wherein the stylus comprises plural orifices through each of which a respective strip may be dispensed.

15. A craft kit as claimed in claim 13 wherein the stylus incorporates a mechanism for severing the strip dispensed therefrom.

16. A craft kit as claimed in claim 6 and further comprising a chosen number of strips each of a chosen length, and an illustration of a plurality of different representations which the strips are capable of being formed into.

17. A craft kit as claimed in claim 6 wherein said releasable holding means is in the form of a hook and loop fastening mechanism.

18. A craft kit as claimed in claim 17 wherein the substrate comprises the hook element of the fastening mechanism, to which the strip or strips are attachable by the nature of their material.

19. A craft kit as claimed in claim 6 wherein said releasable holding means uses the force of magnetic attraction.

20. A craft kit as claimed in claim 6 wherein the substrate comprises an item of clothing.

21. A craft kit as claimed in claim 6 wherein the substrate comprises a body having a substantially closed surface.

22. A stylus for use with a craft kit as claimed in claim 6, the stylus comprising an orifice through which a strip may be dispensed, allowing the stylus to be used to apply the strip to a substrate.

23. A stylus according to claim 22, comprising plural orifices through each of which a respective strip can be dispensed.

24. (canceled)
